(19) United States
(12) Patent Application Publication
(10) Pub. No.: US 2015/0103518 A1
(43) Pub. Date: Apr. 16, 2015

(54) SOLAR LAMP WITH ADJUSTABLE HEIGHT

(71) Applicant: Shou Qiang ZHU, Ontario, CA (US)

(72) Inventor: Shou Qiang ZHU, Ontario, CA (US)

(73) Assignee: IP POWER HOLDINGS LIMITED, Hong Kong (CN)

(21) Appl. No.: 14/515,495

(22) Filed: Oct. 15, 2014

Related U.S. Application Data
(60) Provisional application No. 61/890,880, filed on Oct. 15, 2013.

(51) Int. Cl. F21V 21/22; F21S 8/08; F21S 9/03

(52) U.S. Cl. CPC F21V 21/22; F21S 9/035; F21S 8/081; F21W 2131/109
USPC 362/183; 362/362

(57) ABSTRACT

A solar lamp may include a bottom plate, a lamp post, and a lighting complex. In one embodiment, the lamp post is fixed to the bottom plate and has three segments. The three segments are retractable thereby allowing the height of the lamp post to be adjusted. The lighting complex is installed at the top end of the lamp post and comprises a housing and a solar panel which is placed onto the top side of the housing. The housing may include a frame and with glass panels installed, and enclose a LED lamp, a rechargeable battery, and required wirings. The present invention is advantageous because the solar lamp can be easily and quickly installed or uninstalled, and the height of the lamp post can be easily and conveniently adjusted.

### CROSS-REFERENCE TO RELATED APPLICATIONS

This application claims priority under 35 U.S.C. §119 (e) to U.S. Provisional Patent Application Ser. No. 61/890,880, filed on Oct. 15, 2013, the entire contents of which are hereby incorporated by reference.

### FIELD OF INVENTION

The present invention relates to lamp, and more specifically to a solar lamp with adjustable height that can be easily and rapidly installed, and the height of the lamp can be conveniently and easily adjusted.

### BACKGROUND OF THE INVENTION

Landscaping becomes more and more popular in recent years because people have a much higher demand on quality of their living environment. Outdoor lights are usually installed to illuminate buildings, gardens, pathways, and entranceways for safety purposes by reducing and eliminating dark hiding places and unobserved entry points for intruders. Moreover, the outdoor lights can be arranged to decorate the gardens, patios or yards to enhance the aesthetic value thereof. Recently, photovoltaic solar panels are integrated into the outdoor lights, so the sun light can be converted into electrical energy and the energy can be stored in a connected rechargeable battery that can be used to provide electricity for an outdoor lamp when lighting is required. The combination of outdoor lights with solar panels allows the lighting devices to be readily available in the areas where electrical lines are not available, and at a lower operating cost than using conventional lighting devices.

One common problem of many conventional outdoor light fixtures is that once the lighting fixture is installed, it is very difficult and inconvenient to uninstall and the process to uninstall is usually costly and labor-intensive because the light itself is heavy and tall. In addition, current outdoor lights may not allow convenient adjustment of the height, so it requires a large storage space to store the light. Therefore, there remains a need for a new and improved outdoor light to overcome the problems illustrated above.

### SUMMARY OF THE INVENTION

It is an object of the present invention to provide a solar lamp structure that can be easily and quickly installed or uninstalled, and the height of the lamp post can be conveniently adjusted by adjusting the post segments of the lamp.

It is another object of the present invention to provide a solar lamp structure, the height of which can be easily adjusted for different landscaping designs.

It is a further object of the present invention to provide an outdoor solar lamp structure to absorb the sun light, convert it into electrical energy, and store the electrical energy in a connected rechargeable battery for the outdoor lamp when lighting is required.

A solar lamp with adjustable height may include a bottom plate, a lamp post and a lighting complex. In one embodiment, the bottom plate is a square shaped metal plate with four connecting holes each located at one of the four sides of the bottom plate. A screw bolt will be inserted into corresponding connecting holes to secure the lamp on the ground. The bottom plate may be made by steel or other metals, and the weight of the bottom plate may be different for different purposes. For example, if the user wants the lamp to stand alone stably on a flat surface, the weight of the bottom plate has to increase. The shape of the bottom plate and the number of connecting holes described above can be changed according to the actual usage of the lamp.

In one embodiment, the lamp post has three segments: a first segment, a second segment, and a third segment. The first segment is fastened to the bottom plate. The second segment, which has a smaller size than the first segment, can be received inside a first receiving space in the first segment when the user wants to lower the heights of the solar lamp. A first connector is located between the first segment and second segment to connect both segments, and the first connector has a first inner securing unit to prevent the second segment from undesirable falling into the first receiving space. Likewise, the third segment is, which has a smaller size than the second segment, can be received inside a second receiving space when the user wants to further lower the height of the solar lamp, and a second connector is located between the second segment and third segment to connect both segments and prevent the third segment from undesirable falling into the second receiving space through a second inner securing unit inside the second connector.

When the user wants to lower the height of the lamp, he/she can push a second button located outside the second segment to unlock the second inner securing unit of the second connector, so the third segment can be received in the second receiving space to lower the height of the lamp. Likewise, when the user wants to further lower the height of the lamp, he/she can push a first button located outside the first segment to unlock the first inner securing unit of the first connector, so the second segment (with the third segment inside) can be received in the first receiving space to further lower the height of the lamp.

Reversely, the user can press the first button to pull out the second segment until the first inner securing unit in the first connector restrict the movement of the second segment. The user can further increase the height of the lamp by pressing the second button to pull out the third segment to restore the original height of the lamp.

In other words, the segments of the lamp post are telescopically connected, so the height of the solar lamp in the present invention can be easily adjusted as stated above according to the user's preference. This feature saves the storage space for the solar lamp and allows convenient handling and transposition.

### BRIEF DESCRIPTION OF THE DRAWINGS

FIG. 1 is a perspective view showing the original height of the lamp in the present invention.

FIG. 2 is an enlarged view of the light post segments of the lamp in the present invention.

FIG. 3 is a perspective view showing the lamp with a decreased height in the present invention.

FIG. 4 is a perspective view showing the minimum height of the lamp in the present invention.

FIG. 5 is a schematic view of the solar panel on top of the lamp in the present invention.

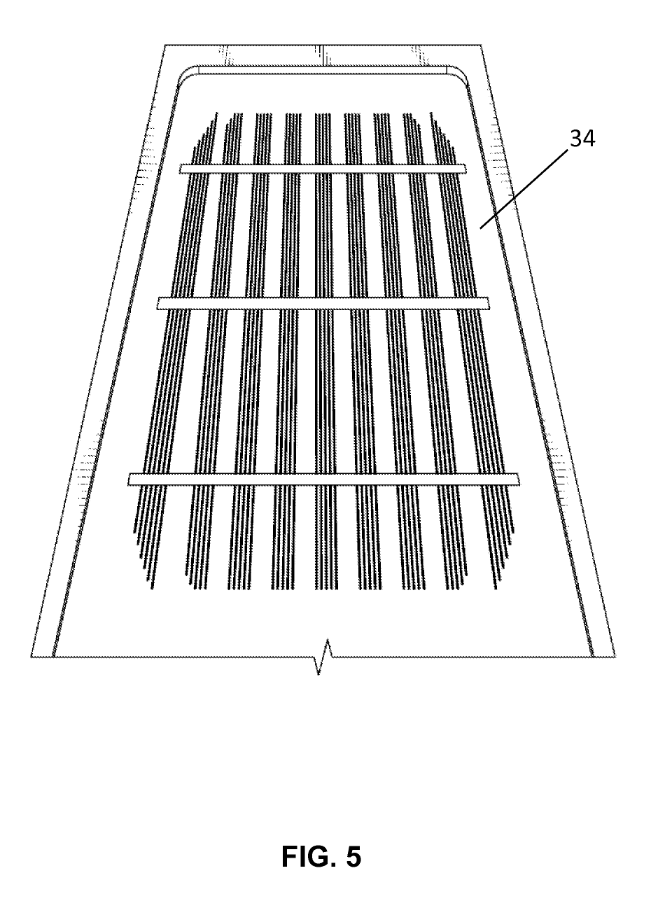

FIG. 6 illustrates another aspect of the solar lamp in the present invention.

FIG. 7 illustrates the solar panel and light housing in FIG. 6 in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

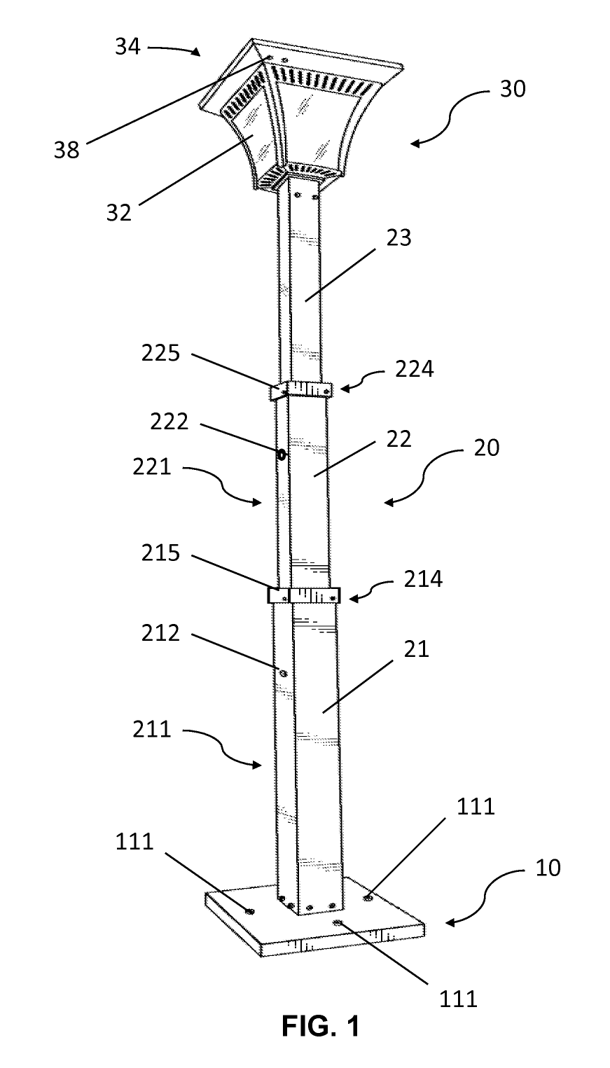

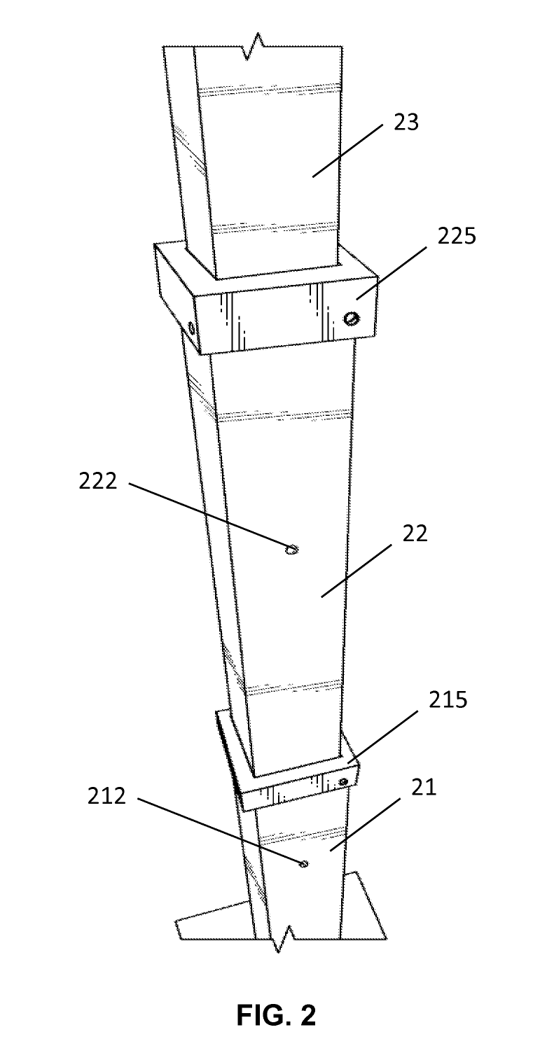

As shown in FIGS. 1 and 2, a solar lamp with adjustable height may include a bottom plate 10, a lamp post 20 and a lighting complex 30. In one embodiment, the bottom plate 10 is a square shaped metal plate with four connecting holes 111 each located at one of the four sides of the bottom plate 10. A screw bolt will be inserted into corresponding connecting holes 111 to secure the lamp on the ground. The bottom plate 10 may be made by steel or other metals, and the weight of the bottom plate 10 may be different for different purposes. For example, if the user wants the lamp to stand alone stably on a flat surface, the weight of the bottom plate 10 has to increase. The shape of the bottom plate 10 and the number of connecting holes described above can be changed according to the actual usage of the lamp.

In one embodiment as shown in FIGS. 1 and 2, the lamp post 20 has three segments: a first segment 21, a second segment 22, and a third segment 23. The first segment 21 is fastened to the bottom plate 10. The second segment 22, which has a smaller size than the first segment 21, can be received inside a first receiving space 211 in the first segment 21 when the user wants to lower the heights of the solar lamp. A first connector 215 is located between the first segment 21 and second segment 22 to connect both segments, and the first connector has a first inner securing unit 214 to prevent the second segment 22 from undesirable falling into the first receiving space 211. Likewise, the third segment 23 is, which has a smaller size than the second segment 22, can be received inside a second receiving space 221 when the user wants to further lower the height of the solar lamp, and a second connector 225 is located between the second segment 22 and third segment 23 to connect both segments and prevent the third segment 23 from undesirable falling into the second receiving space 221 through a second inner securing unit 224 inside the second connector 225.

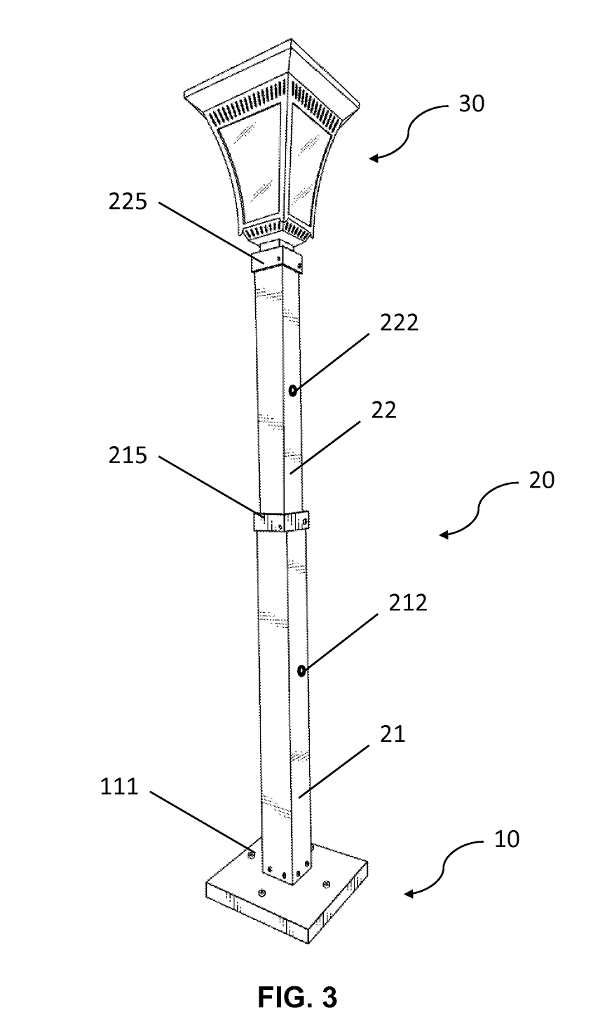

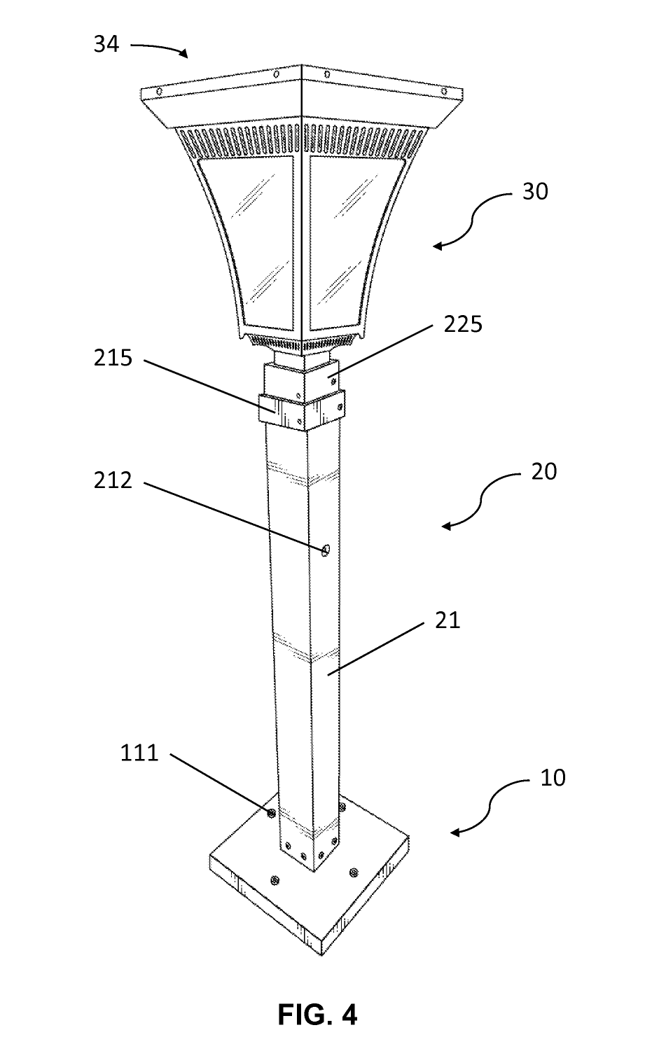

Still referring to FIGS. 1 and 2, when the user wants to lower the height of the lamp, he/she can push a second button 222 located outside the second segment 22 to unlock the second inner securing unit 224 of the second connector 225, so the third segment 23 can be received in the second receiving space 221 to lower the height of the lamp, as shown in FIG. 3. Likewise, when the user wants to further lower the height of the lamp, he/she can push a first button 212 located outside the first segment 21 to unlock the first inner securing unit 214 of the first connector 215, so the second segment 22 (with the third segment 23 inside) can be received in the first receiving space 211 to further lower the height of the lamp, as shown in FIG. 4.

Reversely, the user can restore the height of the solar lamp shown in FIG. 4. More specifically, the user can press the first button 212 to pull out the second segment 22 until the first inner securing unit 214 in the first connector 215 restrict the movement of the second segment 22. The user can further increase the height of the lamp by pressing the second button 222 to pull out the third segment 23 to restore the height of the lamp as shown in FIG. 1. In other words, the segments of the lamp post 20 are telescopically connected, so the height of the solar lamp in the present invention can be easily adjusted as stated above according to the user's preference. This feature saves the storage space for the solar lamp and allows convenient handling and transposition.

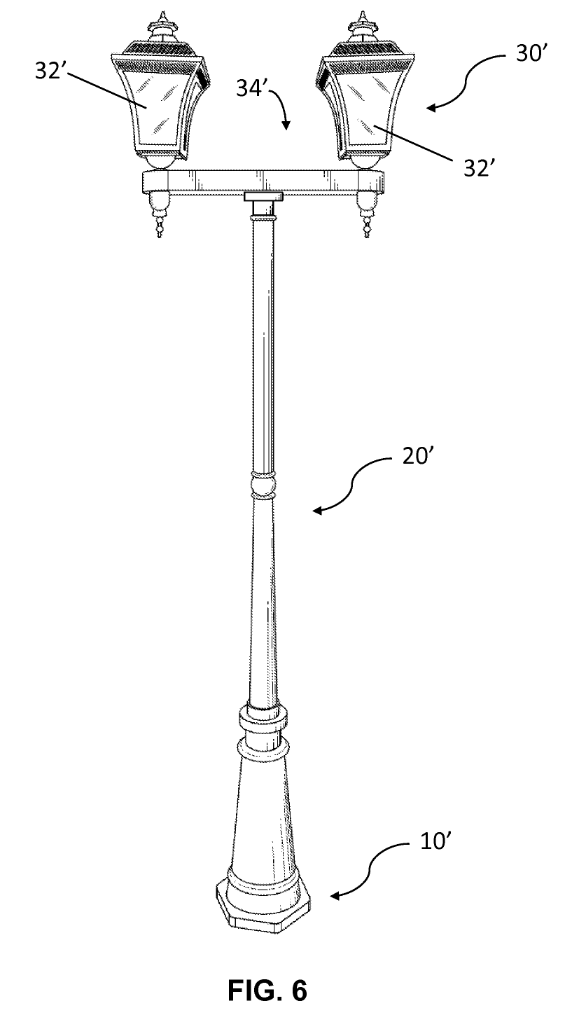

The lighting complex 30 is disposed at the top of the third segment 23 of the lamp post 20. The lighting complex 30 may comprise a housing 32 and a solar panel 34 placed on the top of the housing 32, as shown in FIGS. 1 and 6. In one embodiment, the housing 32 may enclose an LED lamp, a rechargeable battery, and related wiring devices to connect the LED lamp to the battery and to connect the battery to the solar panel 34. An on/off switch button that controls the solar LED lamp is disposed at a bottom portion of the housing 32. The solar panel 34 is disposed on top of the housing 32 and is facing upward for sun light collection. The sun light collected by the solar panel 34 can be converted to electrical energy and stored in the rechargeable battery, and when the user turns on the LED lamp, the LED lamp can be powered by the rechargeable battery.

In addition to height adjustment, the solar lamp in the present invention can be easily installed and uninstalled on the ground. In one embodiment, the solar lamp can be installed on the ground through screw bolts. In another embodiment, the solar lamp can be installed on the ground through ground stakes. The present invention is advantageous for users who may frequently move the solar lamp around in the yard.

The lighting complex 30 of the solar lamp of the present invention has other advantages over current solar lamps. The lighting complex 30 has a light intensity sensor 38 which allows the solar lamp to be turned on or off automatically depending on the environmental light intensity.

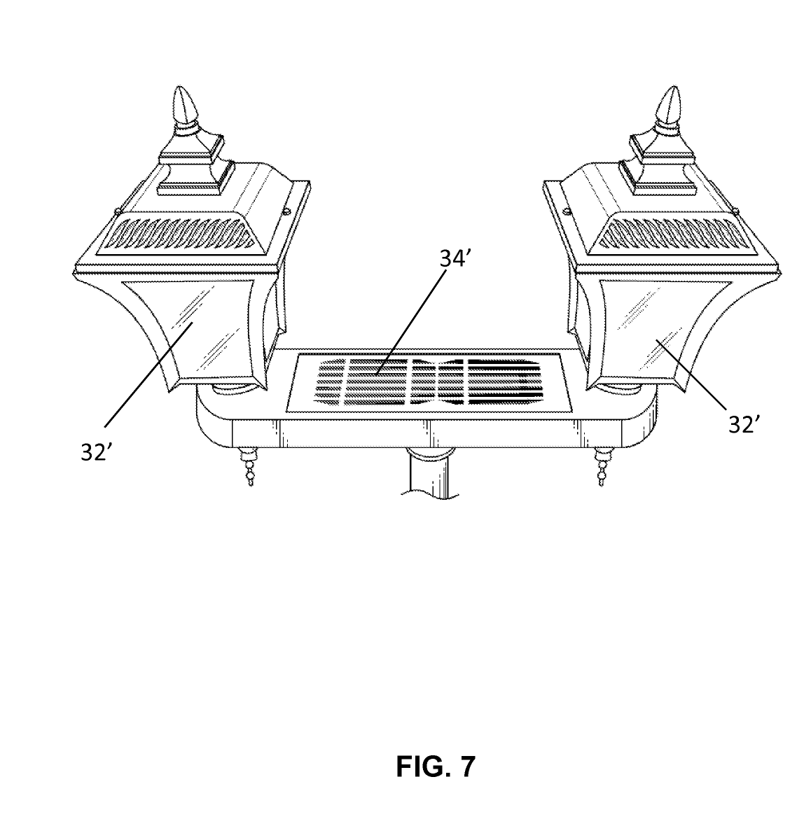

In another aspect, the solar lamp may include a bottom plate 10′ a lamp post 20′ and a lighting complex 30′ as shown in FIGS. 6 and 7. In one embodiment, the lamp post 20′ can be adjusted telescopically. The lighting complex 30′ has more than one housing 32′ for more than one lamps. Unlike the light complex 30 that has the solar panel 34 on top of the housing 32, the solar panel 34′ in lighting complex 30′ is disposed at a base 36′ underneath the housing 32′. The rechargeable battery and wirings are disposed inside the base 36′ to connect with the housing 32′.

The above description and illustrations are for one exemplary embodiment or a few exemplary embodiments of the present invention and should not be considered to limit the scope of the implementation of the present invention. Accordingly, the present invention is not to be considered as limited by the forgoing description, but includes any equivalents.

What is claimed is:

1. A solar lamp comprising a bottom plate; a lamp post having a plurality of segments that are telescopically connected; and a lighting complex having a housing and a solar panel, wherein the height of the solar lamp is adjustable by controlling the number of segments of the lamp post.

2. The solar lamp of claim 1, wherein the bottom plate is a square shaped metal plate with four connecting holes each located at one of the four sides of the bottom plate, and a screw bolt will be inserted into corresponding connecting holes to secure the lamp on the ground.

3. The solar lamp of claim 1, wherein the lamp post has a first segment, a second segment, and a third segment; the size of the first segment is greater than the second segment, and the size of the second segment is greater than the third segment; and the first segment is fastened on the bottom plate.

4. The solar lamp of claim 3, wherein the first segment and the second segment are hollow, having a first receiving space and a second receiving space respectively; the first receiving space is configured to receive the second segment while the second receiving space is configured to receive the third segment.

5. The solar lamp of claim 4, wherein the first segment and second segment are connected by a first connector, while the second segment and the third segment are connected by a second connector.

6. The solar lamp of claim 5, wherein the first connector has a first inner securing unit to secure the second segment to prevent undesirable falling into the first receiving space, while the second connector has a second inner securing unit to secure the third segment to prevent undesirable falling into the second receiving space.

7. The solar lamp of claim 6, wherein a second button is located outside the second segment is used to unlock the second inner securing unit of the second connector, so the third segment is received in the second receiving space to lower the height of the solar lamp; and a first button is located outside the first segment to unlock the first inner securing unit of the first connector, so the second segment with the third segment therein is received in the first receiving space to further lower the height of the solar lamp.

8. The solar lamp of claim 7, wherein by pressing the first button, the second segment is pulled out from the first receiving space until the first inner securing unit restricts the movement of the second segment, while by pressing the second button, the third segment is pull out from the second receiving space until the second inner securing unit restricts the movement of the third segment to restore the height of the solar lamp.

9. The solar lamp of claim 1, wherein the lighting complex is disposed at a top portion of the third segment of the lamp post, and the lighting complex comprises a housing and a solar panel placed on the top of the housing.

10. The solar lamp of claim 9, wherein the housing includes an LED lamp, a rechargeable battery, and related wiring devices to connect the LED lamp to the battery and to connect the battery to the solar panel.

11. The solar lamp of claim 10, wherein the solar panel is disposed on top of the housing and facing upward for sun light collection; the sun light collected by the solar panel is converted to electrical energy and stored in the rechargeable battery, and when the user turns on the LED lamp, the LED lamp is powered by the rechargeable battery.

12. The solar lamp of claim 1, wherein the solar panel is disposed underneath the housing.
